(19) United States
(12) Patent Application Publication
(10) Pub. No.: US 2012/0067131 A1
(43) Pub. Date: Mar. 22, 2012

(54) HIGH PRESSURE SENSOR

(76) Inventors: Thomas Moelkner, Stuttgart (DE); Wilhelm Frey, Stuttgart (DE)

(21) Appl. No.: 13/258,564

(22) PCT Filed: Mar. 12, 2010
(86) PCT No.: PCT/EP2010/053201

§ 371 Date: Dec. 8, 2011

(30) Foreign Application Priority Data
May 11, 2009 (DE) 102009002990.7

(51) Int. Cl. G01L 7/08

(52) U.S. Cl. 73/715

(57) ABSTRACT

A construction concept for high-pressure sensors is provided, enabling simple and economical manufacture of reliable high-pressure sensors even for pressure ranges above 2200 bar. A high-pressure sensor of this kind encompasses a sensor element for pressure sensing and a connector piece for coupling the sensor element to a measured system, a diaphragm being embodied over a blind opening in the base element of the sensor element, a pressure conduit being embodied in the base element of the connector piece, and the sensor element being mounted on the connector piece in such a way that the diaphragm can be impinged upon, through the pressure conduit that opens into the blind opening, by a measured pressure. The blind opening in the base element of the sensor element is embodied, at least in one portion, in a manner tapering conically toward the diaphragm, and that end of the pressure conduit which faces toward the sensor element is tubular in shape. This tubular end of the pressure conduit is pressed into the blind opening so that the tube wall is pressed, at least in a circumferential region, sealingly against the side wall of the blind opening.

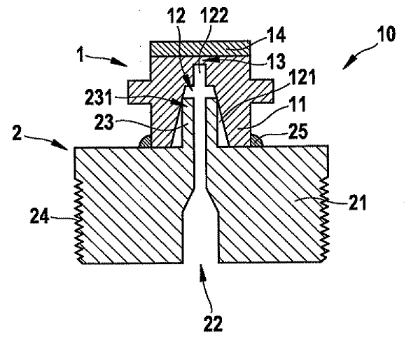

### FIELD OF THE INVENTION

The present invention relates to a high-pressure sensor having a sensor element for pressure sensing, and having a connector piece for coupling the sensor element to a measured system. A diaphragm is embodied over a blind opening in the base element of the sensor element, and a pressure conduit is embodied in the base element of the connector piece. The sensor element is mounted on the connector piece in such a way that the diaphragm can be impinged upon, through the pressure conduit that opens into the blind opening, by a measured pressure.

The sensor element and the connector piece are usually fabricated independently of one another, each from a metallic base element. In the case of the sensor element, a blind opening is generated in the base element in order to expose a diaphragm in the oppositely located surface of the base element. A functional layer having circuit elements for signal acquisition is applied onto the diaphragm surface, semiconductor technology methods preferably being used for this purpose. A pressure conduit is embodied in the base element of the connector piece. In addition, the connector piece can also be equipped, for example, with a thread for coupling to the measured system. The sensor element is then mounted on the connector piece in such a way that the pressure conduit opens into the rearward blind opening of the sensor element, in which context the connection between the sensor element and the connector piece must be pressure-tight.

A variety of concepts for constructing high-pressure sensors of this kind, having a sensor element and a connector piece, are known from practical use. Mounting of the sensor element on the connector piece proves to be problematic in particular when the high-pressure sensor is to be used in a pressure range above 2200 bar.

For cost reasons, the sensor element is usually welded to the connector piece. Care must be taken in this context that neither the pressure conduit in the connector piece nor the blind opening of the sensor element becomes sealed off, contaminated, or unfavorably deformed; this complicates production of a welded connection having reproducible mechanical properties. The compressive strength of the welded connection is influenced by the geometry of the weld bead and of the contact surfaces thereof with respect to the sensor element and the connector piece. Notches or depressions in the welded connection constitute initiation points for cracks under high pressure loads, in particular in the case of pulsating loads. The field of application of such high-pressure sensors is therefore typically limited to pressure ranges below 2200 bar.

Clamped connections are more reliable than a welded connection between the sensor element and connector piece. They are suitable even for use at pressures greater than 10,000 bar. The costs associated therewith are, however, very high, so that this construction and connection technology is utilized only in very small production runs for special applications.

Lastly, be it further noted that the sensor element and the connector piece can also be produced in one piece from a metallic base element. In this case, however, because of the component size, the circuit elements for signal acquisition cannot readily be applied onto the sensor diaphragm using semiconductor technology methods.

### SUMMARY OF THE INVENTION

The present invention provides a construction concept for high-pressure sensors that enables simple and economical production of reliable high-pressure sensors even for pressure ranges above 2200 bar.

For this purpose, according to the present invention the blind opening in the base element of the sensor element is embodied, at least in one portion, in a manner tapering conically toward the diaphragm, whereas that end of the pressure conduit which faces toward the sensor element is tubular in shape. According to the present invention, this tubular end of the pressure conduit is pressed into the blind opening so that the tube wall is pressed, at least in a circumferential region, sealingly against the side wall of the blind opening.

According to the present invention, sealing of the outlet opening region between the pressure conduit of the connector piece and the blind opening of the sensor element is decoupled from the mechanical fastening of the sensor element on the connector piece. According to the present invention, the sealing effect is attained by pressing the tubular end of the pressure conduit into the conically shaped blind opening in the rear side of the sensor element. Clamped seals of this kind are particularly reliable even in the high-pressure region above 2200 bar. The sealing effect here is independent of a mechanical connection of the base elements of the sensor element and connector piece. The mechanical connection between the two base elements can consequently be disposed at a distance from the outlet opening region between the pressure conduit and blind opening. Because this mechanical connection does not need to be pressure-tight but instead serves only to fasten the sensor configuration in place, any connection technology can be used therefor.

In a very simple variant of the high-pressure sensor according to the present invention, the tubular end of the pressure conduit has a circular cross section that is constant over its entire length. In this case the free end of the pressure conduit is pressed sealingly against the side wall of the blind opening. A sealing effect that is better in comparison therewith can be attained if the tubular end of the pressure conduit has a conical reduction, and the conical slope of this reduction is greater than the conical slope of the blind opening. The reason is that thanks to this feature, the overall contact surface between the tube wall and side wall of the blind opening can be enlarged. In addition, mounting of the sensor element on the connector piece is simplified with this embodiment of the tubular end.

As already mentioned, the mechanical connection between the base elements of the sensor element and connector piece can be produced in any desired manner. In a particularly economical variant, the base element of the sensor element sits on the base element of the connector piece and is welded thereto in the edge region of the connecting surface.

### BRIEF DESCRIPTION OF THE DRAWING

The FIGURE shows a high-pressure sensor according to the present invention.

### DETAILED DESCRIPTION

High-pressure sensor 10 depicted in the FIGURE encompasses a sensor element 1 for pressure sensing and a connector piece 2 for coupling sensor element 1 to a measured system (not depicted here). Both sensor element 1 and connector piece 2 are fabricated from a respective metal base element 11, 21.

A blind opening 12 has been produced in base element 11 of sensor element 1 in order to expose a diaphragm 13 in the oppositely located surface of base element 11. This blind opening 12 has an opening region 121, tapering conically toward diaphragm 13, that transitions into a cylindrical end region 122. A functional layer 14 having circuit elements for sensing diaphragm deformations has been applied onto diaphragm 13.

A through conduit, constituting a pressure conduit 22 having a tubular prolongation 23, is embodied in base element 21 of connector piece 2. The circular cross section of pressure conduit 22 tapers, in the middle region of base element 21, down to the cross-sectional area of its tubular prolongation 23. In addition, an external thread 24 is embodied in the outer side of connector piece 2 so that high-pressure sensor 10 can be threaded into a corresponding connector opening of the measured system.

Sensor element 1 has been mounted on connector piece 2 in such a way that pressure conduit 22 opens into blind opening 12 below diaphragm 13. To allow diaphragm 13 to be impinged upon by a measured pressure via pressure conduit 22, the tubular end 23 of pressure conduit 22 has been pressed into blind opening 12 of sensor element 1 so that free end 231 of the cylindrical tube wall is pressed sealingly against that portion of the side wall of blind opening 12 which tapers conically toward diaphragm 13. This clamped seal withstands even very high pressures.

Blind opening 12 in base element 11 of sensor element 1, and tubular end 23 of pressure conduit 22, are dimensioned and configured so that the sealing effect described above occurs when base element 11 of sensor element 1 sits on base element 21 of connector piece 2. In the exemplifying embodiment of the invention depicted here, this assemblage is fastened by way of a weld bead 25 extending circumferentially around the connecting surface of the two base elements 11 and 21.

1-4. (canceled)

5. A high-pressure sensor comprising:
a sensor element for pressure sensing;
a connector piece for coupling the sensor element to a measured system;
a diaphragm situated over a blind opening in a base element of the sensor element; and
a pressure conduit situated in a base element of the connector piece,
wherein the sensor element is mounted on the connector piece in such a way that the diaphragm can be impinged upon, through the pressure conduit that opens into the blind opening, by a measured pressure,
wherein the blind opening in the base element of the sensor element is situated, at least in one portion, in a manner tapering conically toward the diaphragm,
wherein an end of the pressure conduit which faces toward the sensor element is tubular in shape,
wherein the tubular end of the pressure conduit is pressed into the blind opening so that a tube wall is pressed, at least in a circumferential region, sealingly against a side wall of the blind opening, and
wherein the base element of the sensor element sits on the base element of the connector piece and is fastened by way of at least one weld connection, the fastening being implemented independently of the sealing.

6. The high-pressure sensor according to claim 5, wherein the tubular end of the pressure conduit has a conical reduction, a conical slope of the reduction being greater than a conical slope of the blind opening.

7. The high-pressure sensor according to claim 5, wherein the fastening and the sealing are accomplished physically separately from one another.

8. The high-pressure sensor according to claim 5, wherein the base element of the sensor element sits on the base element of the connector piece, the two base elements being welded together in an edge region of a connecting surface.
